(19) United States
(12) Patent Application Publication
(10) Pub. No.: US 2018/0360223 A1
(43) Pub. Date: Dec. 20, 2018

(54) Coupling Assembly

(71) Applicant: Robert LaCount, Niagara Falls, NY (US)

(72) Inventor: Robert LaCount, Niagara Falls, NY (US)

(21) Appl. No.: 15/625,090

(22) Filed: Jun. 16, 2017

(51) Int. Cl. A47C 7/66; F16B 2/06; F16B 7/04

(52) U.S. Cl. CPC A47C 7/66; F16B 7/0433; F16B 2/065

(57) ABSTRACT

A coupling assembly for coupling an umbrella to a chair includes a pair of clamps. Each clamp comprises a plate. A pair of cutouts is positioned in the plate. A pair of couplers is coupled to the plate. Each coupler is positioned adjacent to a respective cutout. Each coupler is configured to couple to a respective rod, such as a leg of a chair and a pole of an umbrella. A respective cutout of each plate is configured to insert the leg of the chair and a respective cutout of each plate is configured to insert the pole of the umbrella. The pair of couplers of each plate is configured to couple singly to the leg of the chair and the pole of the umbrella to couple the umbrella to the chair.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to coupling assemblies and more particularly pertains to a new coupling assembly for coupling an umbrella to a chair.

### BRIEF SUMMARY OF THE INVENTION

An embodiment of the disclosure meets the needs presented above by generally comprising a pair of clamps. Each clamp comprises a plate. A pair of cutouts is positioned in the plate. A pair of couplers is coupled to the plate. Each coupler is positioned adjacent to a respective cutout. Each coupler is configured to couple to a respective rod, such as a leg of a chair and a pole of an umbrella. A respective cutout of each plate is configured to insert the leg of the chair and a respective cutout of each plate is configured to insert the pole of the umbrella. The pair of couplers of each plate is configured to couple singly to the leg of the chair and the pole of the umbrella to couple the umbrella to the chair.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a coupling assembly according to an embodiment of the disclosure.

FIG. 2 is a top view of an embodiment of the disclosure.

FIG. 3 is an end view of an embodiment of the disclosure.

FIG. 4 is a bottom view of an embodiment of the disclosure.

FIG. 5 is an in-use view of an embodiment of the disclosure.

### DETAILED DESCRIPTION OF THE INVENTION

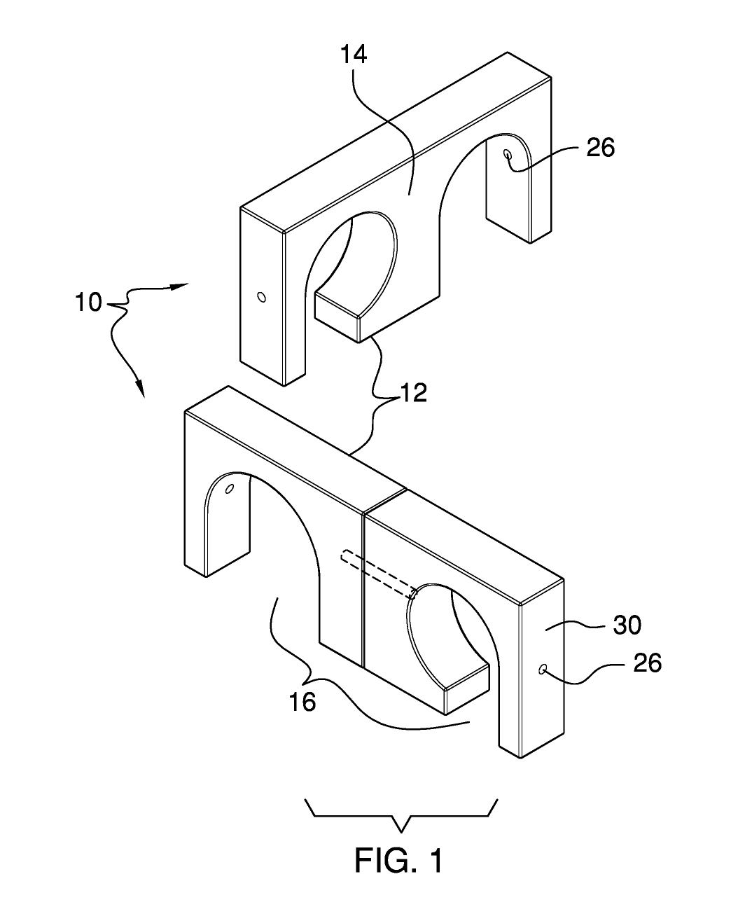

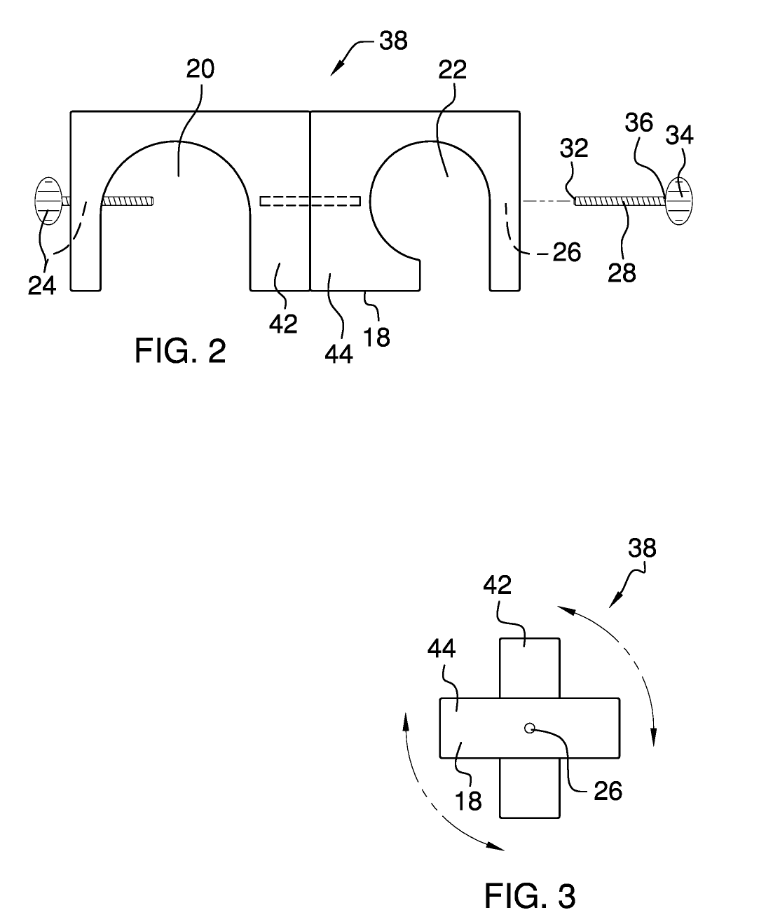

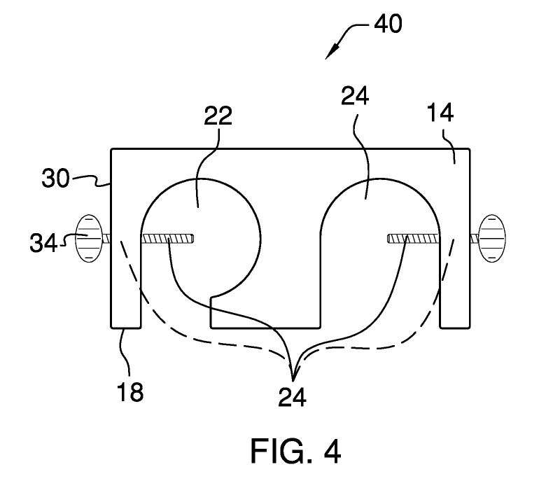

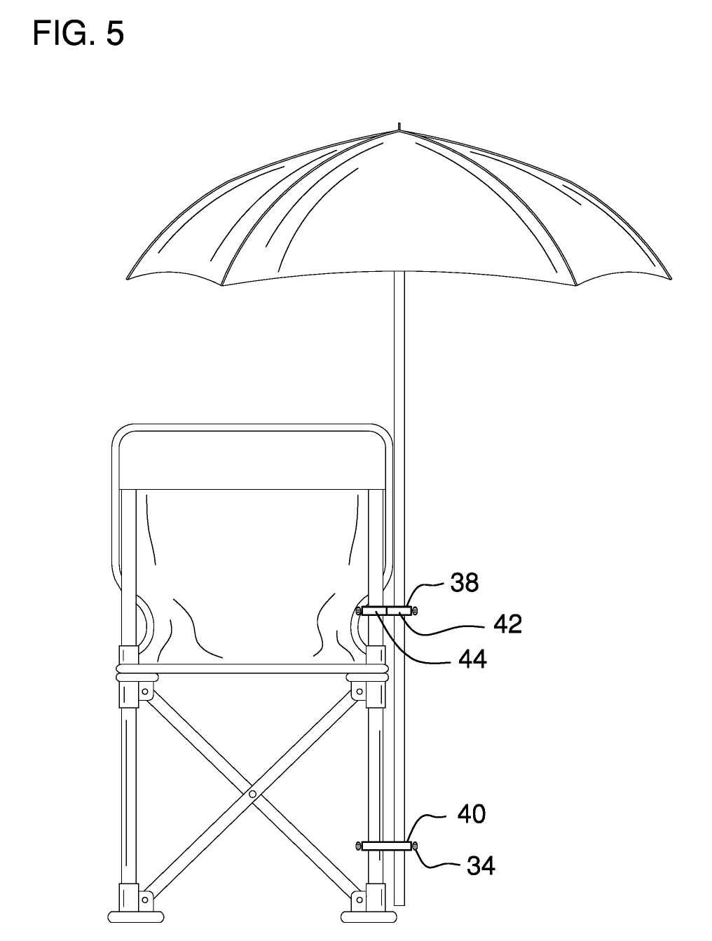

With reference now to the drawings, and in particular to FIGS. 1 through 5 thereof, a new coupling assembly embodying the principles and concepts of an embodiment of the disclosure and generally designated by the reference numeral 10 will be described.

As best illustrated in FIGS. 1 through 5, the coupling assembly 10 generally comprises a pair of clamps 12. Each clamp 12 comprises a plate 14. In one embodiment, the plate 14 is substantially rectangularly box shaped. In another embodiment, the plate 14 comprises aluminum. In yet another embodiment, the plate 14 comprises plastic.

A pair of cutouts 16 is positioned in the plate 14. Each cutout 16 is configured to insert a respective rod, such as a leg of a chair and a pole of an umbrella. In one embodiment, the pair of cutouts 16 extends into the plate 14 from a respective opposing side 18 of the plate 14. The pair of cutouts 16 comprises a first recess 20 and a second recess 22. In another embodiment, the first recess 20 is U-shaped and the second recess 22 is P-shaped.

A pair of couplers 24 is coupled to the plate 14. Each coupler 24 is positioned adjacent to a respective cutout 16. Each coupler 24 is configured to couple to the respective rod, such as the leg of the chair and the pole of the umbrella. The pair of couplers 24 is configured to couple singly to the leg of the chair and the pole of the umbrella to couple the umbrella to the chair.

In one embodiment, each coupler 24 comprises a hole 26 and a bolt 28. The hole 26 is positioned in a respective opposing end 30 of the plate 14 and extends to an associated cutout 16. The hole 26 is threaded. The bolt 28 is complementary to the hole 26. The hole 26 is positioned to threadedly insert the bolt 28. A first end 32 of the bolt 28 protrudes into the associated cutout 16. The bolt 28 is configured to frictionally couple to the respective rod that is positioned in the associated cutout 16 to couple the respective rod to the plate 14.

In another embodiment, a head 34 is coupled to a second end 36 of the bolt 28. The head 34 is configured to be grasped in digits of a hand of a user to apply rotational force to the bolt 28 to reversibly couple the bolt 28 to the respective rod that is positioned in the associated cutout 16. In yet another embodiment, the head 34 is ovally shaped and extends axially from the bolt 28.

In one embodiment, the pair of clamps 12 comprises a first bracket 38 and a second bracket 40. The plate 14 of the first bracket 38 comprises a first section 42 and a second section 44. The first section 42 is pivotally coupled to the second section 44. The pair of cutouts 16 is positioned singly in the first section 42 and the second section 44. The pole of the umbrella that is positioned in a respective cutout 16 is pivotable relative to the leg of the chair to which the first bracket 38 is coupled. In another embodiment, the first bracket 38 is dimensionally larger than the second bracket 40.

In use, a respective cutout 16 of each plate 14 is configured to insert the leg of the chair and a respective cutout 16 of each plate 14 is configured to insert the pole of the umbrella. The holes 26 are positioned in the plates 14 such that each hole 26 is positioned to threadedly insert a respective bolt 28. The first end 32 of the respective bolt 28 protrudes into the associated cutout 16. The respective bolt 28 is configured to frictionally couple to the respective rod that is positioned in the associated cutout 16. The pair of couplers 24 of each plate 14 is configured to couple singly to the leg of the chair and the pole of the umbrella to couple the umbrella to the chair.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A coupling assembly comprising:
a pair of clamps, each said clamp comprising:
a plate, each one of said plates comprising a first section and a second section, said first section being pivotally coupled to said second section,
a pair of cutouts positioned in said plate, said pair of cutouts being positioned singly in said first section and said second section wherein said cutouts are rotatable relative to each other, and
a pair of couplers coupled to said plate, each said coupler being positioned adjacent to a respective said cutout, each said coupler being configured for coupling to a respective rod; and
wherein said cutouts are positioned in said plates such that a respective said cutout of each said plate is configured for inserting the leg of the chair and a respective said cutout of each said plate is configured for inserting the pole of the umbrella, wherein each said pair of couplers is positioned on a respective said plate such that said pair of couplers of each said plate is configured for coupling singly to the leg of the chair and the pole of the umbrella for coupling the umbrella to the chair.

2. The assembly of claim 1, further including each of said plates being substantially rectangularly box shaped.

3. The assembly of claim 1, further including each of said plates comprising aluminum.

4. The assembly of claim 1, further including each of said plates comprising plastic.

5. The assembly of claim 1, further including said pair of cutouts extending into said plate from a common side of said plate.

6. The assembly of claim 1, further including said pair of cutouts comprising a first recess and a second recess, said first recess being U-shaped, said second recess being P-shaped.

7. The assembly of claim 1, further including each said coupler comprising:
a hole, said hole being positioned in a respective opposing end of said plate and extending to an associated said cutout, said hole being threaded;
a bolt, said bolt being complementary to said hole; and
wherein said hole is positioned in said plate such that said hole is positioned for threadedly inserting said bolt such that a first end of said bolt protrudes into said associated said cutout such that said bolt is configured for frictionally coupling to the respective rod positioned in said associated said cutout for coupling the respective rod to said plate.

8. The assembly of claim 7, further including a head coupled to a second end of said bolt, wherein said head is positioned on said bolt such that said head is configured for grasping in digits of a hand of a user for applying rotational force to said bolt for reversibly coupling said bolt to the respective rod positioned in said associated said cutout.

9. The assembly of claim 8, further including said head being ovally shaped, said head extending axially from said bolt.

10. (canceled)

11. (canceled)

12. A coupling assembly comprising:
a pair of clamps, each said clamp comprising:
a plate, said plate being substantially rectangularly box shaped each one of said plates comprising a first section and a second section, said first section being pivotally coupled to said second section,
a pair of cutouts positioned in said plate, wherein said cutouts are positioned in said plate such that each said cutout is configured for inserting a respective rod, each of said pair of cutouts extending into said plate from a respective opposing side of said plate, said pair of cutouts comprising a first recess and a second recess, said first recess being U-shaped, said second recess being P-shaped, and
a pair of couplers coupled to said plate, each said coupler being positioned adjacent to a respective said cutout, each said coupler being configured for coupling to the respective rod, wherein said couplers are positioned on said plate such that said pair of couplers is configured for coupling singly to the leg of the chair and the pole of the umbrella for coupling the umbrella to the chair, each said coupler comprising:
a hole, said hole being positioned in a respective opposing end of said plate and extending to an associated said cutout, said hole being threaded,
a bolt, said bolt being complementary to said hole, wherein said hole is positioned in said plate such that said hole is positioned for threadedly inserting said bolt such that a first end of said bolt protrudes into said associated said cutout such that said bolt is configured for frictionally coupling to the respective rod positioned in said associated said cutout for coupling the respective rod to said plate, and
a head coupled to a second end of said bolt, wherein said head is positioned on said bolt such that said head is configured for grasping in digits of a hand of a user for applying rotational force to said bolt for reversibly coupling said bolt to the respective rod positioned in said associated said cutout, said head being ovally shaped, said head extending axially from said bolt;
said pair of cutouts being positioned singly in said first section and said second section wherein said cutouts are rotatable relative to each other, and
wherein said cutouts are positioned in said plates such that a respective said cutout of each said plate is configured for inserting the leg of the chair and a respective said cutout of each said plate is configured for inserting the pole of the umbrella, wherein said holes are positioned in said plates such that each said hole is positioned for threadedly inserting a respective said bolt such that a first end of said respective said bolt protrudes into said associated said cutout such that said respective said bolt is configured for frictionally coupling to the respective rod positioned in said associated said cutout such that said pair of couplers of each said plate is configured for coupling singly to the leg of the chair and the pole of the umbrella for coupling the umbrella to the chair.
